(19) United States
(12) Patent Application Publication
(10) Pub. No.: US 2013/0017518 A1
(43) Pub. Date: Jan. 17, 2013

(54) Method of Permanently Removing Repeating Upsetting Emotions and Behaviors Associated with a Person, Persons, Events, and Situations

(71) Applicants: Vincent George KUBILUS, Santa Rosa, CA (US); Richard Crowley, Santa Barbara, CA (US)

(72) Inventors: Vincent George KUBILUS, Santa Rosa, CA (US); Richard Crowley, Santa Barbara, CA (US)

(21) Appl. No.: 13/550,135

(22) Filed: Jul. 16, 2012

Related U.S. Application Data
(60) Provisional application No. 61/507,866, filed on Jul. 14, 2011.

(51) Int. Cl. G09B 19/00

(52) U.S. Cl. 434/236

(57) ABSTRACT

The present invention is a method to permanently remove repeating upsetting emotions and behaviors that are associated with a person, persons, events, and situations. This method is intended for use as an application with electronic devices in which instructions can be displayed to a user through a graphic user interface. The user performs an emotional transformation process by following the instructions which can be in the form of steps, processes, or imagination exercises. The emotional transformation process eliminates the repeating patterns that cause repeating upsetting emotions and replaces the upsetting emotions with positive emotions. The emotional transformation process takes place within the user's imagination in which feelings, thoughts, and emotions are formed into images within the imagination. The user is not required to input specific details about a troubling issue causing the upsetting emotions, nor is the user required to analyze the specific details and troubling issues.

The current application claims a priority to the U.S. Provisional Patent application Ser. No. 61/507,866 filed on Jul. 14, 2011. The current application is filed in the U.S. on Jul. 16, 2012 while Jul. 14, 2012 was on a weekend.

### FIELD OF THE INVENTION

The present invention relates generally to right-brain hemisphere focused personal emotional and behavioral transformation spontaneously generated by an individual's imagination. More particularly, the object of the present invention is to allow a user to permanently eliminate repetitive upsetting emotions and behaviors associated with a person, persons, events, and situations by removing the underlying repeating patterns that generate the upsetting emotions through the user's imagination.

### BACKGROUND OF THE INVENTION

Many individuals experience upsetting emotions and/or various behaviors associated with a specific person, persons, events and situations. For example, an individual may feel upsetting emotions, which may be associated with a specific person. The particular issue with this specific person may be addressed through counseling to attempt to eliminate the upsetting emotions. However, visiting a mental health professional in order to alleviate these problems does not guarantee that the underlying patterns, which generated the upsetting emotions in the first place, will be permanently eliminated.

A pattern is an organized energy pathway in right brain that causes an individual to perceive and react to a person, persons, events and situations in a repetitive predictable manner each time that the individual finds themselves in a condition that resembles previous encounters. Patterns' natures cause them to operate in predictable, repetitive ways as described below:
Patterns exist in the unconscious, where memories about everything that has ever happened in an individual's are stored. Patterns make use of every bit of this information to defend themselves from an individual's attempts to recognize and destroy them.
Although the pattern knows everything about the individual and will use the information to protect itself, the pattern cannot think. A pattern is similar to a physical virus that invades the nucleus of the cell. A virus knows how to ensure its survival and to use the nucleus to reproduce itself, but the virus, like a pattern, cannot think. Patterns, viruses and bacteria operate on survival instinct rather than logical thought.
The behavior of all patterns follows a predictable, repetitive and sequential path. For example, an individual become frustrated or angry when something does not produce an expected result. Patterns dictate that an individual will behave in such a predictable way, which is a reaction, not a response.
Patterns have only one motivation and that is their continued survival, which always is at the expense of an individual's peace of mind and enjoyment of life.
Patterns use an individual's emotional energy to prevent the individual from becoming aware of their existence and interfering with their operations or destroying them.
Every action that the individual takes that is motivated by a pattern will strengthen the pattern. This includes talking about the pattern and resisting an emotion or feeling that is associated with the pattern. For example, avoiding or dismissing thoughts about an annoying relative, neighbor or boss will intensify and prolong the annoying feelings associated with the thoughts.
Everything within the individual's unconscious also operates continuously even during their physical sleep. The patterns never sleep or take any time off. Everything, including dreams, that the individual perceives is filtered by the patterns' operations. An individual is unknowingly compelled by patterns to interpret, or rather misinterpret, what is happening and what has happened in a way that preserves or enhances the patterns' existence.

Oftentimes, analyzing the memory associated with the upsetting emotions and behaviors will only strengthen the underlying pattern. It is therefore an object of the present invention to provide a method to permanently eliminate the upsetting emotions associated with the memory by removing the responsible underlying repeating pattern itself. Another problem associated with visiting a mental health professional is that the individual must dictate, reveal, or share in some manner, intimate details about the upsetting issue. This can make the individual feel uncomfortable and could be counterproductive to any type of emotional transformation process. People do not enter conventional mental health counseling for some of the following reasons:
They have no insurance.
They cannot afford an insurance copayment.
Their job duties and hours do not match the counselor's limited hours.
People do not want counseling on their permanent records.
Many people avoid ‘telling a stranger’ about intimate information as it is too embarrassing or painful to share.
Other people avoid counseling because their presenting problem would be reported to authorities and counseling ends at that moment.

The present invention provides an individual with the following benefits:
No insurance is required.
There is no insurance copayment.
They can enter the process on their hand-held device or other device at their convenience 24 hours per day.
There is no permanent record of their use of the process.
There is no need to provide any personal details about their upsetting issue.
There is no excuse for avoiding counseling out of fear of being reported to authorities.

Therefore, it is also an object of the present invention to allow an individual achieve an emotional transformation process through the use of the individual's imagination without being required to reveal any specific details about the upsetting issue. The emotional transformation process of the imagination is assumed to be the process in which an individual's imagination transforms upsetting emotions and behaviors through a right brain imagination process into positive emotions and behaviors towards a person, persons, events, and situations.

### BRIEF DESCRIPTION OF THE DRAWINGS

FIG. 1 is a flowchart illustrating the supplemental steps of the present invention.

FIG. 2 is a flowchart illustrating the supplemental steps of the present invention.

FIG. 3 is a flowchart illustrating the supplemental steps of the present invention.

FIG. 4 is a flowchart illustrating the supplemental steps of the present invention.

FIG. 5 is a flowchart illustrating the supplemental steps of the present invention.

FIG. 6 is a flowchart illustrating the supplemental steps of the present invention.

FIG. 7 is a flowchart illustrating the supplemental steps of the present invention.

FIG. 8 is a flowchart illustrating the supplemental steps of the present invention.

FIG. 9 is a flowchart illustrating the supplemental steps of the present invention.

FIG. 10 is a flowchart illustrating the supplemental steps of the present invention.

FIG. 11 is a flowchart illustrating the supplemental steps of the present invention.

FIG. 12 is an example drawing of the central pathway.

FIG. 13 is an example list of general upsetting issues categories that could cause upsetting emotions.

FIG. 14 is an example list of specific topics that could cause upsetting emotions.

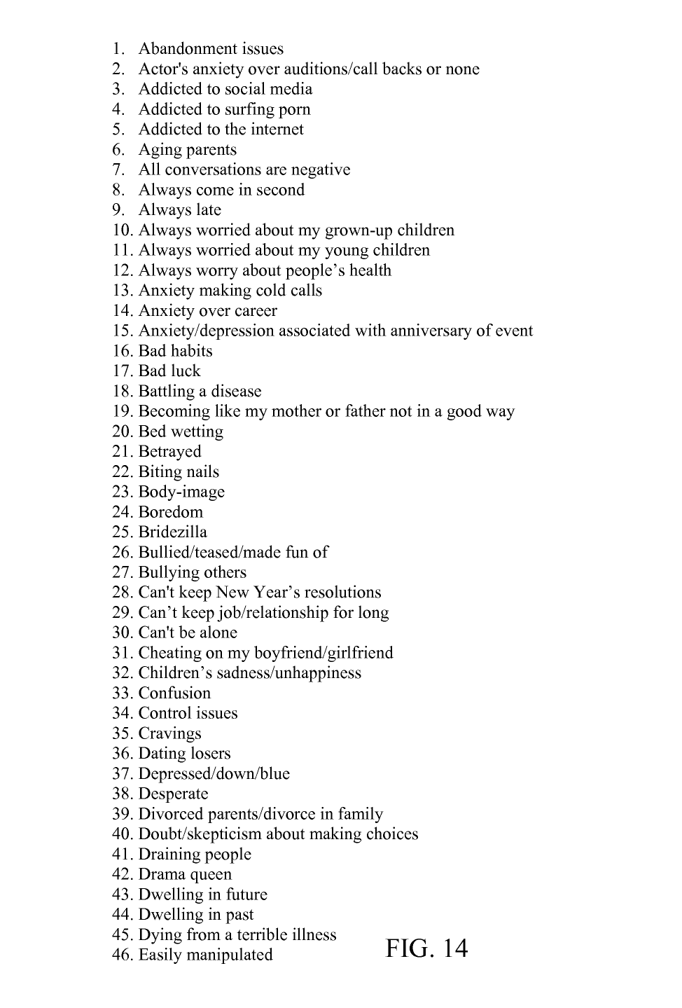

FIG. 15 is an example list of specific topics that could cause upsetting emotions, continued from FIG. 14.

FIG. 16 is an example list of specific topics that could cause upsetting emotions, continued from FIG. 15.

FIG. 17 is an example list of specific topics that could cause upsetting emotions, continued from FIG. 16.

FIG. 18 is an example list of specific topics that could cause upsetting emotions, continued from FIG. 17.

FIG. 19 is an example list of upsetting emotions.

FIG. 20 is an example list of upsetting emotions, continued from FIG. 18.

FIG. 21 is an example list of positive emotions.

### DETAIL DESCRIPTIONS OF THE INVENTION

All illustrations of the drawings are for the purpose of describing selected versions of the present invention and are not intended to limit the scope of the present invention.

The present invention is a software-controlled application that is intended for use with electronic communication devices. However, the processes and methods, which the software follows, can be implemented into any applicable settings. The present invention provides a user with a sequence of instructions in order to permanently remove the underlying repeating patterns of a particular upsetting emotion or behavior. These upsetting emotions and behaviors are typically associated with a person, persons, event, and situations in a user's life. The present invention allows a user without thinking or analyzing, by calling upon the user's right brain imagination, to permanently eliminate and destroy the upsetting emotions at their roots.

The human brain is split into two hemispheres, the left hemisphere and the right hemisphere. In short, the left hemisphere controls the cognitive, analytical, and thinking aspects of the brain. Whereas the right hemisphere controls the emotions and imagination—that which cannot be controlled through thought. For these reasons, the present invention relies on user's imagination. More specifically, the premise of the present invention is that if the user is able to interact with their imagination, the user can then essentially destroy the source of the upsetting emotions that relates to a particular memory or issue associated with a particular person, persons, event or situation and the user's imagination replaces it with an image that produces a positive emotion leading to appropriate behaviors. In order to achieve this, emotions are spontaneously formed into images within the user's imagination that can be transformed into new images, replaced with new images, or destroyed and replaced with new images. Since emotions originate within the right hemisphere, the sensible method to permanently remove the upsetting emotions should occur through the right hemisphere; concurrently, this requires the user to be in a state that is free of thinking and left hemisphere processes.

Instructions are presented through a graphic user interface so that the user does not need to think as the emotional transformation process activates the user's imagination. Also, the user may be required to respond to prompts about the upsetting emotions that will need to be recalled in later steps; therefore the present invention stores this information within a storage database. In the preferred embodiment of the present invention, the graphic user interface is a display screen on a handheld communication device or tablet, although the present invention should not be limited to such devices and any similar existing or future technology could provide this function. Also, the instructions could be read aloud through speakers on the aforementioned communication device without departing from the steps and functions of the present invention.

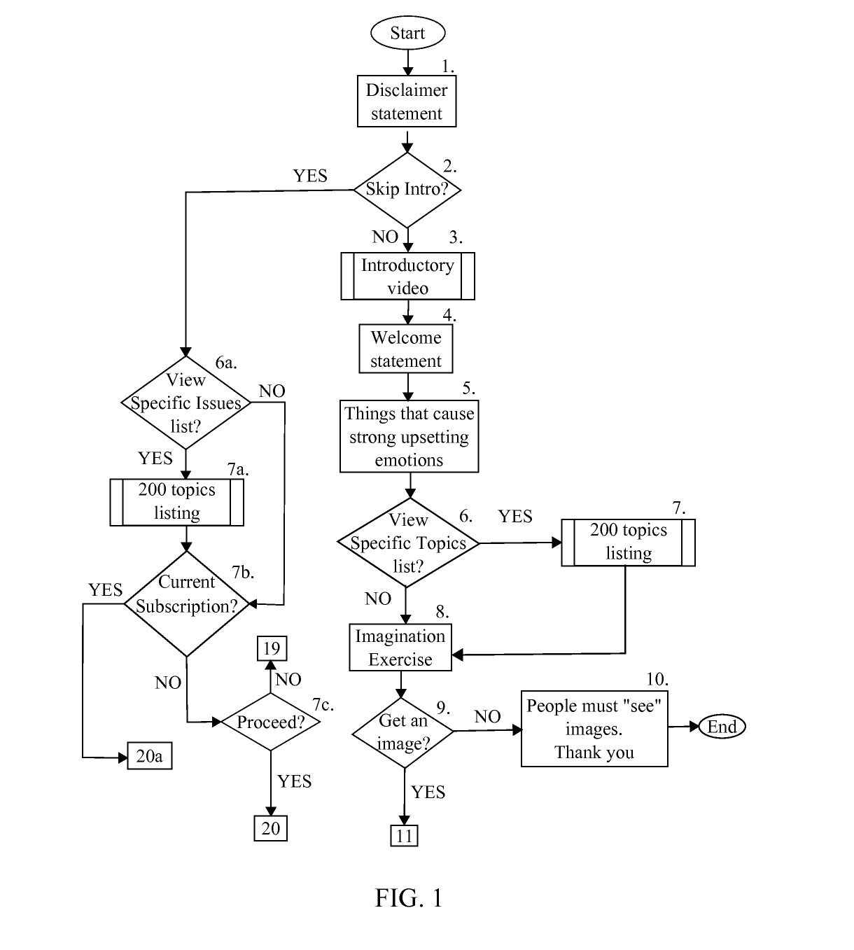

Hereinafter, steps, imagination exercises, and processes will be described that a user is instructed to follow and perform to accomplish the overall process, which is the emotional transformation process of the user's imagination. It is expected that some variation to the steps, imagination exercises, and processes is possible; however, the preferred method of the present invention is delineated within FIG. 1-FIG. 11. Each step, hereinafter described, is labeled for clarification purposes.

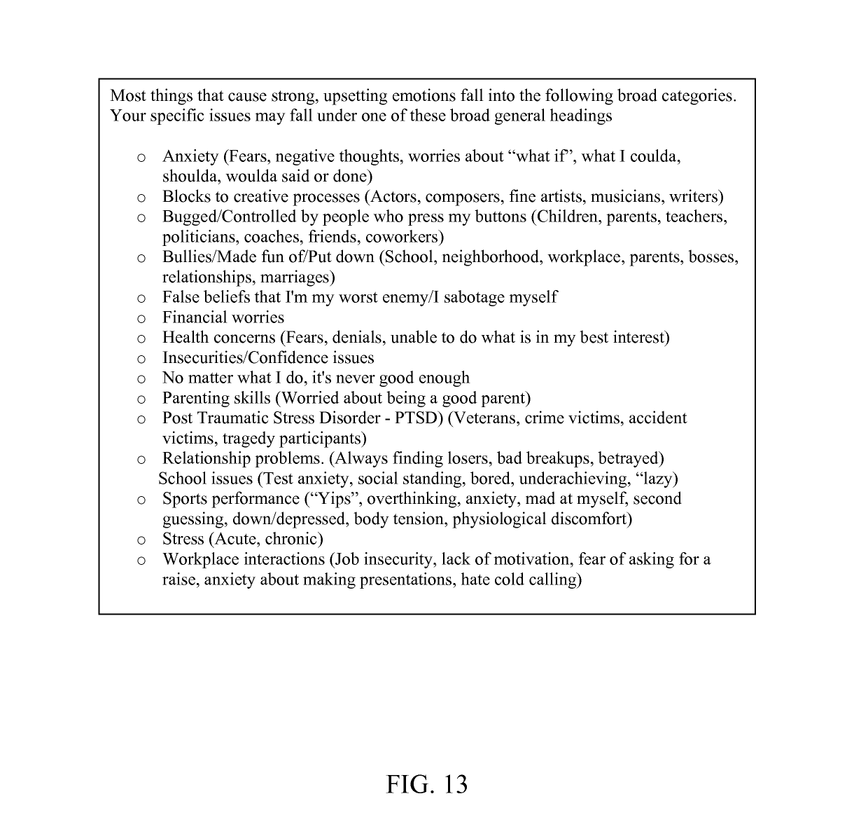

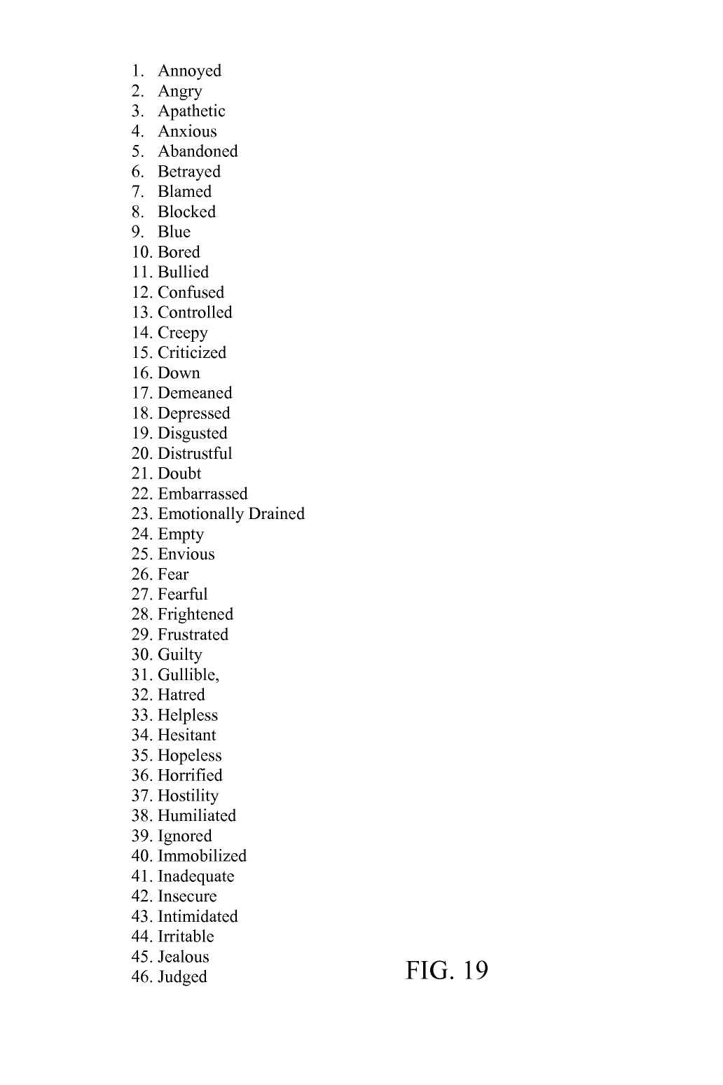

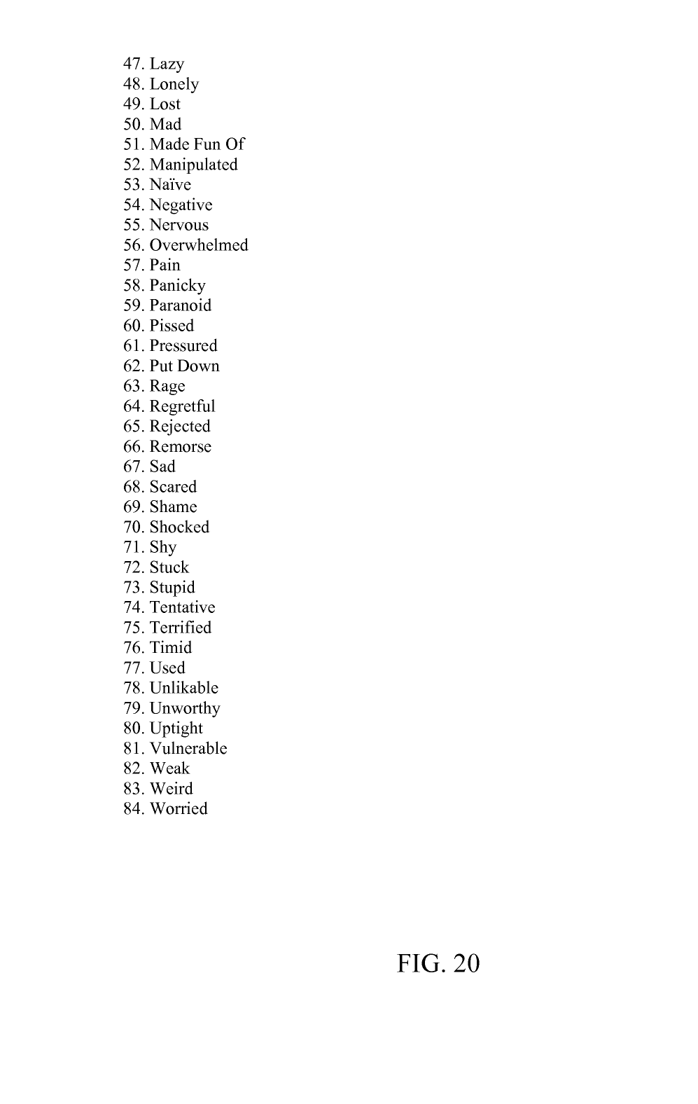

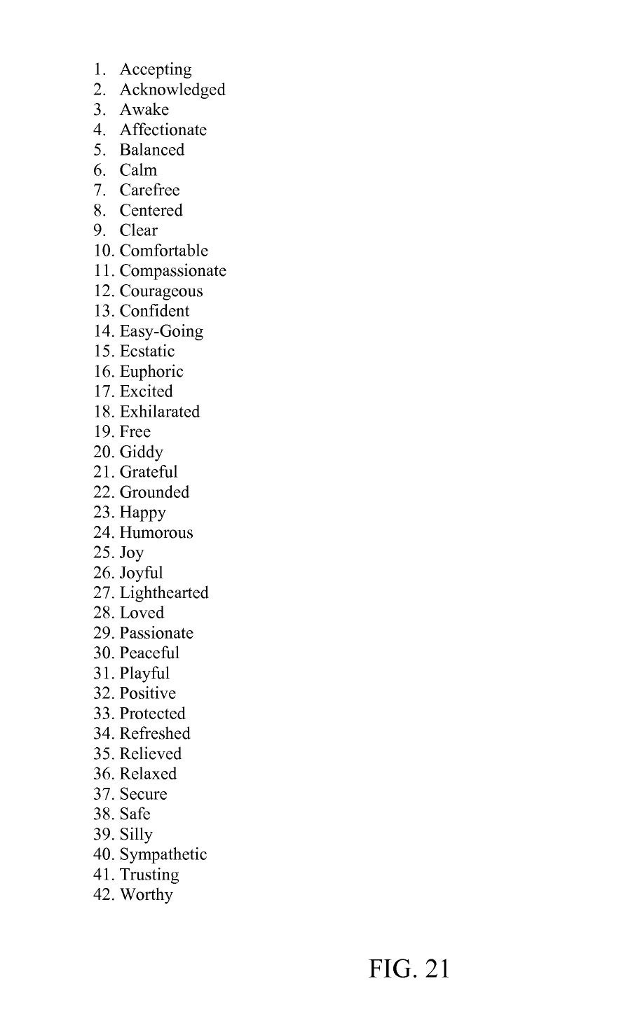

Many of the steps, imagination exercises, and processes are reiterative to ensure that the user permanently removes the repetitive patterns associated with the upsetting emotions and behaviors associated with a person, persons, events and situations. Also, several steps and processes can lead to the termination of the present invention because the user may not understand the object of the processes. The present invention provides the user with a list of upsetting categories, shown in FIG. 13. These categories allow the user to gain an understanding and feeling about generic issues and situations that could cause upsetting emotions. The present invention also provides the user with an upsetting emotions listing, shown in FIG. 19-FIG. 20, and a positive emotions listing, shown in FIG. 21. Each listing has a plurality of standard emotions that are associated with the upsetting emotions listing and the positive emotions listing. An emotional transformation process of the user's imagination to remove the repeating upsetting emotions and behaviors is determined by the manner in which the user's imagination reacts to the instructions. Also, the emotional transformation process is affected by the reaction of the user's imagination towards a plurality of imagination exercises. The user may be required to follow the instructions presented to them or to input information about the reaction of their imagination through a particular process. The main processes that are followed by the present invention are an emotional intensity process, a feeling reporting process, an image forming process, an image intention process, an image education process, and a skeptic process. The primary imagination exercises that a user might perform are an image exercise, an imagination exercise, a central pathway exercise, an image replacement exercise, an image transformation exercise, and an image destruction exercise. If the plurality of imagination exercises is confusing at first to a user, the present invention implements a plurality of helpful explanations to ensure that the user all the necessary tools to remove the upsetting emotions.

A user should be able to use the imagination to visualize an image; an important principle of the present invention. All emotions, whether positive or upsetting, can be formed into an image by the imagination. The imagination does all of the steps required, without the user's effort. The user simply asks the imagination to create an image that represents either the positive or upsetting emotions associated with a person, persons, situations or events in the user's life. The imagination complies by presenting an image in the mind's eye of the user spontaneously throughout the entire emotional transformation process.

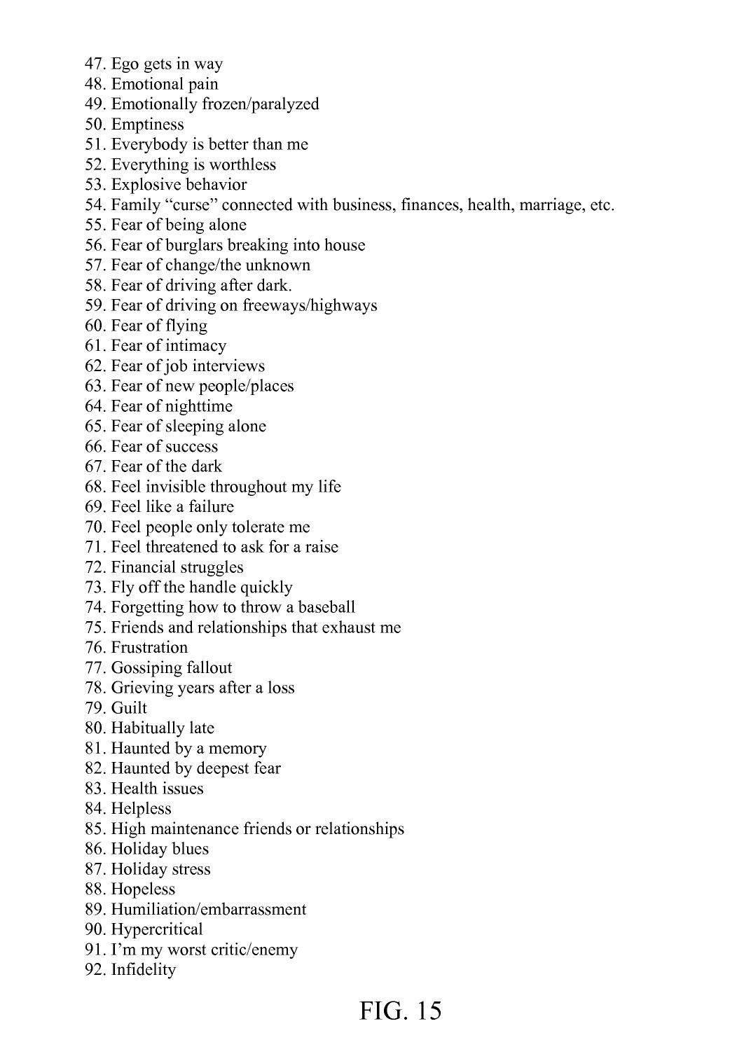

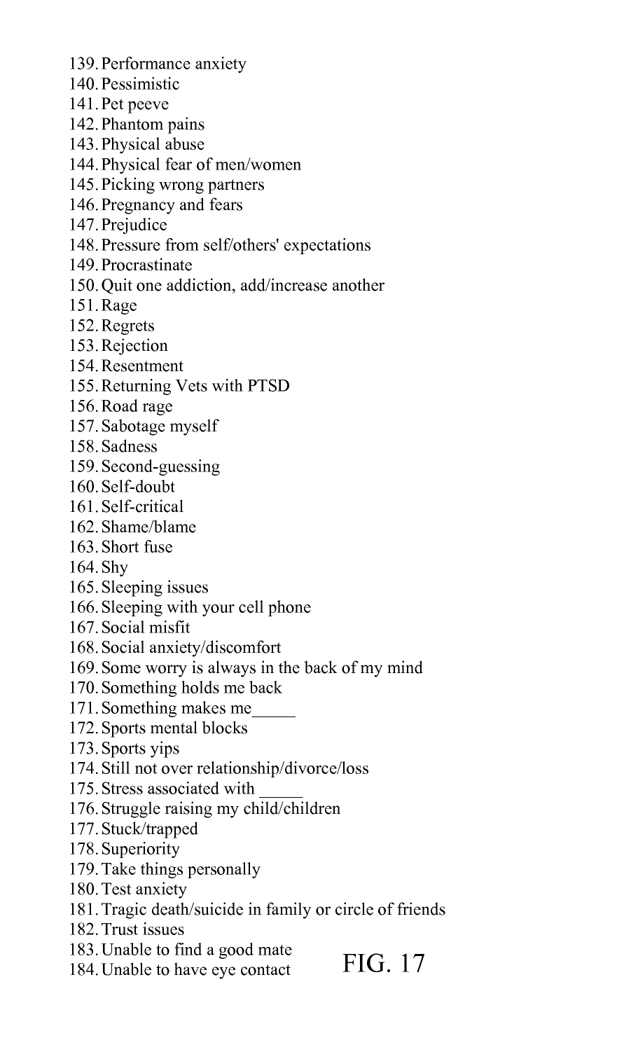

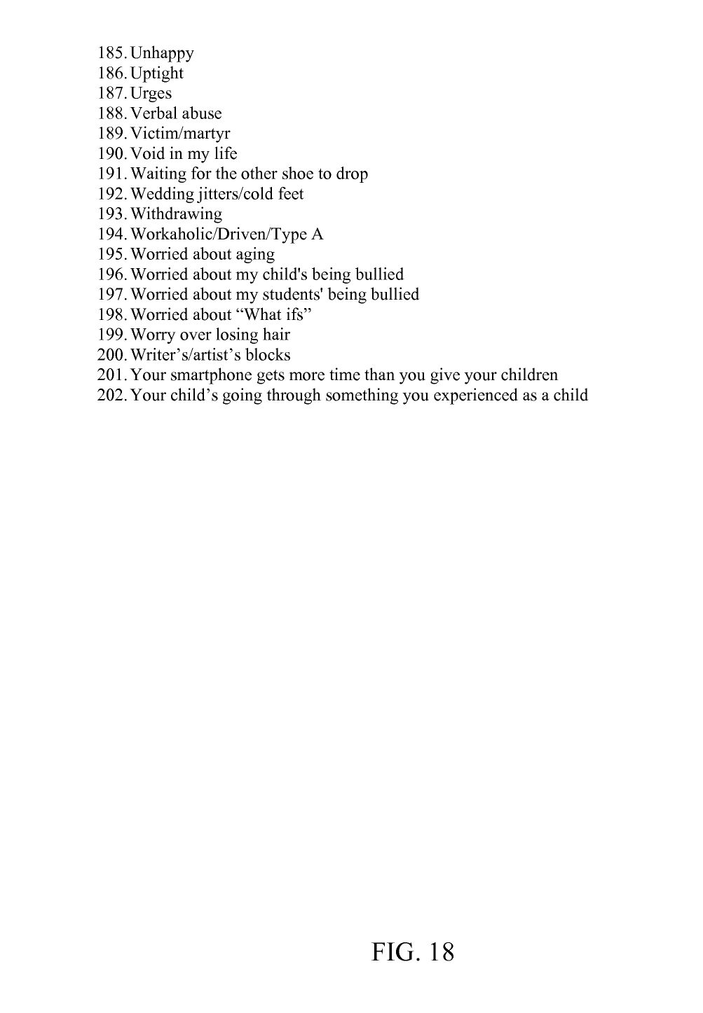

As is delineated within FIG. 1, the method of permanently removing repeating upsetting emotions and behaviors associated with persons, events and situations begins by presenting the user with a list of specific topics (6), shown in FIG. 15-FIG. 19, so that the user can gain an understanding of certain common topics that cause upsetting emotions. FIG. 15-FIG. 19 shows a preferred list of specific topics and should not limit the present invention. Also, a general list of categories of upsetting issues could be presented to a user, as shown in FIG. 13. An image exercise (8) follows this step. This is a simple exercise to ensure that the user can form an image using their imagination. In the preferred embodiment of the imagination exercise, the user is instructed to get an image within their mind of a friend or a familiar person. Then the user is instructed to answer whether or not the image was formed within their mind by inputting a response. If the user was unable to see an image within their mind, then the emotional transformation process does not begin and the method of the present invention is terminated (10). A statement is displayed to the user, such as “Some people cannot get images in their minds while imagining, but can imagine other physical sensations perfectly well. Persons must “see” images in their mind's eye to get benefit from this interactive process. Thank you. Goodbye.” Any statement similar to this could be displayed to the user. A returning user who has already succeeded in destroying a pattern using the emotional transformation process and is already aware of these topics and capable of forming mental images can opt to skip this step and the initial imagination exercises, and then proceed directly to the latter steps and processes of the emotional transformation process.

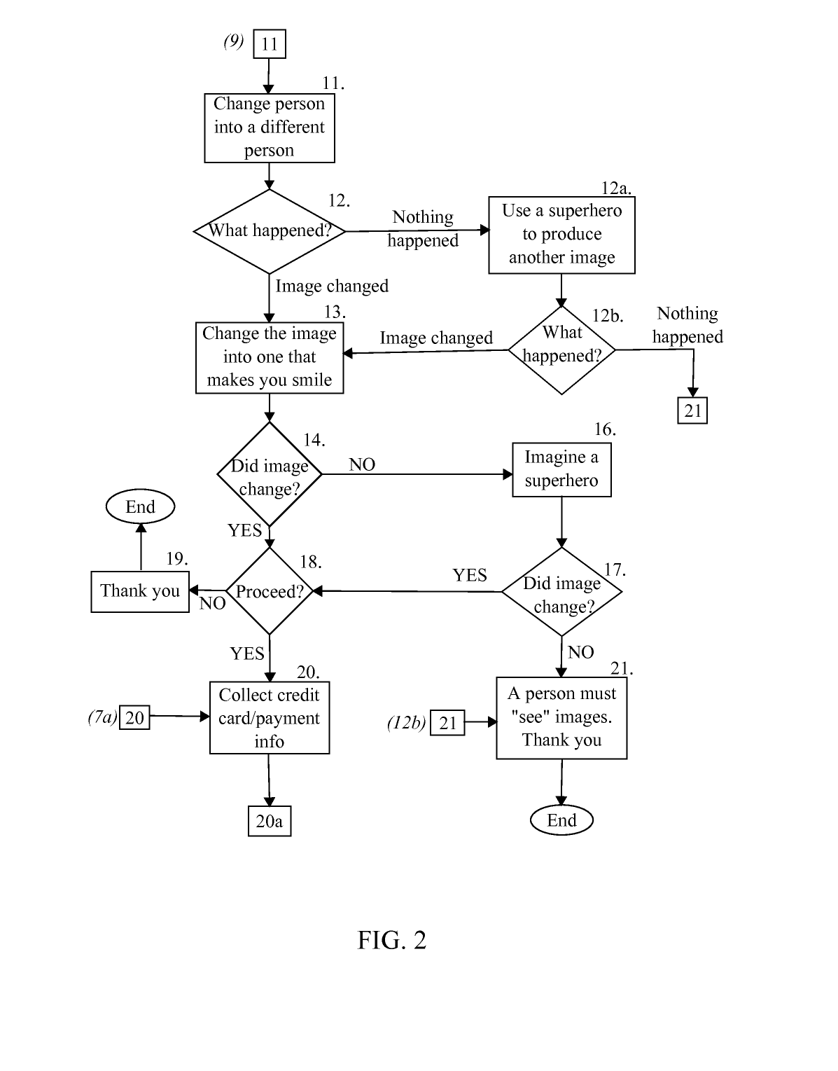

As is delineated within FIG. 2, the user is instructed to continue from the image exercise in which the user must form an image within the imagination, which should be of a friend or a familiar person. The next step of the present invention is image transformation exercise (11), which instructs the user to change or transform this image of a friend or a familiar person into a different person. The user is also instructed to input whether the image changed or if nothing happened (12). If the user inputs that nothing happened, the user is instructed to perform the superhero and mystical figure exercise (12a). The purpose of the superhero and mystical figure exercise is to give the user's imagination assistance in changing the image into a new image. The user is instructed to imagine a superhero or mystical figure first, and then instructed to ask this superhero or mystical figure for assistance in transforming the image. Next the user is instructed to look at the superhero or mystical figure and to ask the superhero or mystical figure to transform the image into a completely different image. The present invention then requires the user to input whether the superhero and mystical figure exercise was successful. If this imagination exercise was unsuccessful, then the emotional transformation process does not begin and the method of the present invention is terminated (21). However, if the superhero and mystical figure exercise was successful and/or if the image transformation exercise was successful, the next step is presented to the user. The next step follows the previous superhero and mystical figure exercise or a response from the image transformation exercise of the image changed. This step instructs the user's imagination to further change the previously transformed image into an image that causes the user to smile (13). The user is required to input whether or not this step was successful (14). If this step was not successful, then the superhero and mystical figure exercise (16) is presented once again to the user, particularly the user's imagination, for assistance. The superhero and mystical figure exercise can be formatted to any step, imagination exercise, or process in order to assist the user, particularly the user's imagination, through any of following steps and processes and hereinafter should be assumed to function in this manner. Also, if any of the plurality of imagination exercises is unsuccessful, hereinafter it should be assumed that the method of the present invention is terminated, along with the emotional transformation process. If the user inputs that the image successfully transformed into an image that causes the user to smile, the user transitions into the next step which is the beginning of the emotional transformation process, effectively.

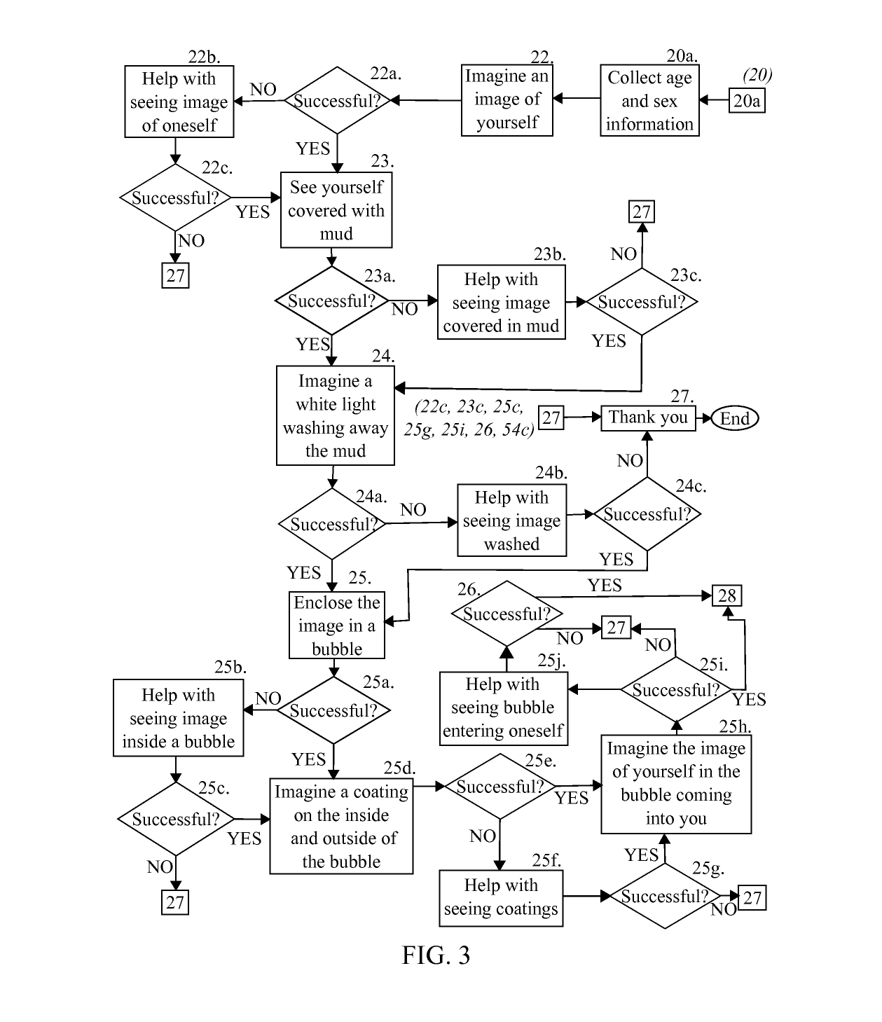

The next step of the present invention, as is delineated by FIG. 3, is the user image exercise (22). The user image exercise instructs the user to imagine an image relating to a self reflection image. In other words, a self reflection image and a user image is an image of the particular form, shape, and/or figure that the user envisions of their own personal form, shape, and/or figure. A user image explanation (22b) is presented to the user if the user is unsuccessful with the user image exercise. Each step, imagination exercise, or process may provide the user with an explanation to assist the user understanding the particular step, imagination exercise, or process so that the emotional transformation process can be as effective as possible. If user image exercise is successful, either initially or through the explanation, the user proceeds to the next step. This step (23) instructs the user to imagine seeing the user image covered with mud; any similar washable substance that could cover the user image could be implemented during this step. If the user is unsuccessful in seeing this image, an explanation (23b) is displayed. If the user successfully imagines the user image covered in mud, the user proceeds to the next step. This step (24) instructs the user to imagine that a white light washes the mud covering the user image away. The preferred method of this step of the present invention instructs the user to imagine washing the mud away with a white light; however the user could be instructed to imagine washing the mud away with any form of light for as long as it is effective. If the user is unsuccessful in visualizing the mud being washed away with the white light, an explanation (24b) is displayed. If the user is successful in imagining the mud being washed away with a white light, the user proceeds to the next step. This next step (25) instructs the user to imagine that the user image is enclosed within a bubble. The preferred method of this step of the present invention is to instruct the user to imagine being enclosed within a bubble that is transparent and protective to the user; however the user could be instructed to imagine being contained within any form of enclosure that appears to be nonthreatening to the user. If the user is unsuccessful in imagining creating a bubble around the user image, an explanation (25b) is displayed. If the user is successful in imagining creating a bubble around the user image, the user proceeds to the next step. This next step is the image coating exercise (25d), which instructs the user to imagine that the inner and outer layers of the bubble is coated with a non-stick substance, that makes it impossible for upsetting mud and debris to stick to the bubble. Also, the user is informed that this non-stick coating substance should have the ability cause any upsetting mud or debris that is aimed at the bubble to be redirected or to slip off from the bubble and away from the bubble. The user is then instructed to tell the imagination to transform any mud or debris that slid off from the bubble into a gold image of balance and harmony. If the user is unsuccessful with the image coating exercise, an explanation is displayed (25f). If the user is successful with the image coating exercise then the user proceeds to the next step. The next step is the bubble absorption exercise (25h), in which the user is instructed to imagine that the user image within the bubble is being absorbed by the user's physical body. Essentially, the user's imagination should understand this step if the user does not; however, the user is displayed an explanation if this bubble absorption exercise is unsuccessful. If the image absorption exercise is successfully completed, the user can proceed to the next steps and processes.

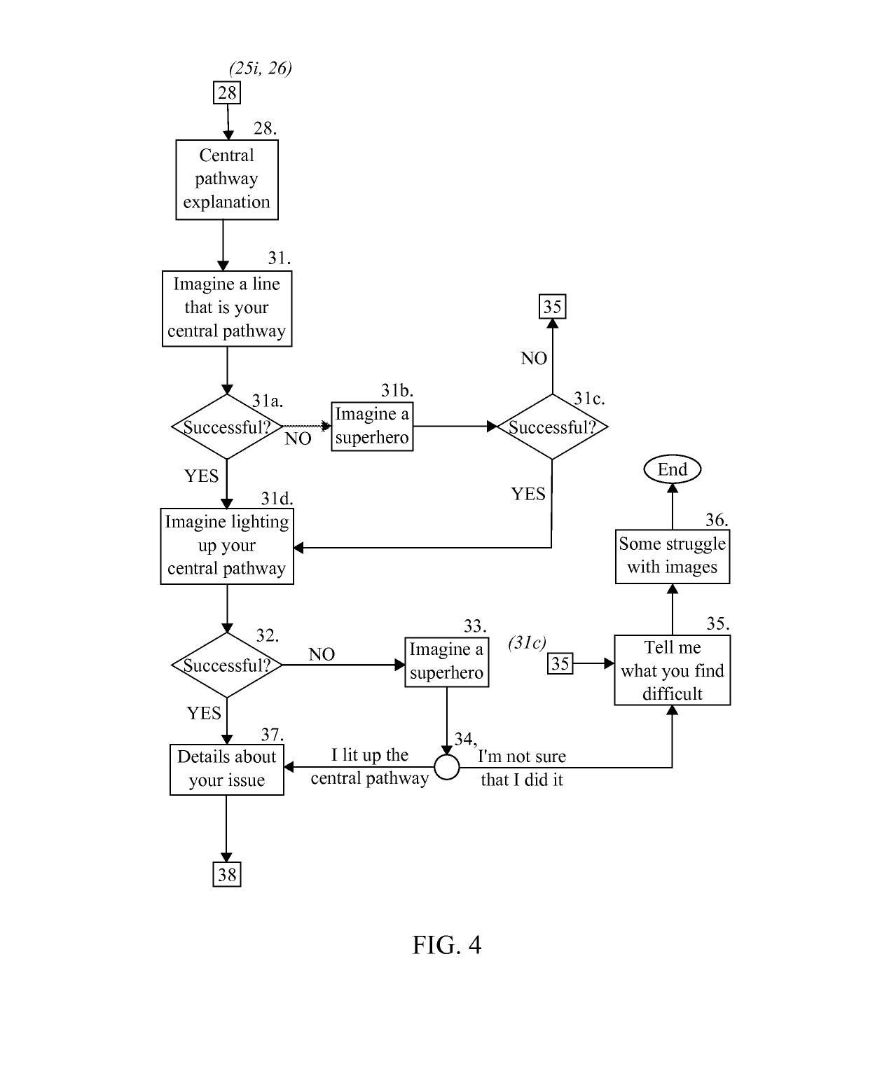

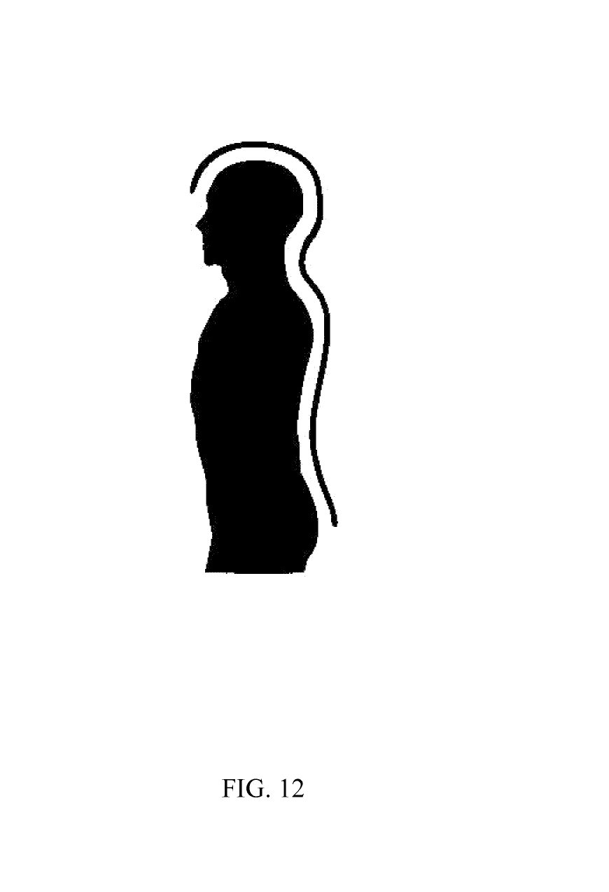

The next step of the present invention, as is delineated by FIG. 4, is the central pathway exercise (28-38). Unlike the previous imagination exercises, a central pathway explanation (28) is displayed initially. Following the central pathway explanation are the instructions to perform the central pathway exercise. The central pathway begins between the eyes of and travels symmetrically to the human body. The line travels around over the skull and down to the tailbone. An example illustration of the central pathway is shown in FIG. 12. The user is instructed to imagine the line of the central pathway (31). If the user is unsuccessful in imagining the line of their central pathway, the user is instructed to perform the superhero and mystical figure exercise (31b). If the user is successful in imagining the central pathway line, the user proceeds to the next step of the central pathway exercise. The next step (31d) instructs the user to imagine lighting up the line of the central pathway in gold light. The preferred method of the central pathway exercise is to instruct the user to imagine lighting up the central pathway with in gold light; however, this light could be any form of light for as long as the method remains effects. If the user is unsuccessful in lighting up the line of their central pathway, the user is instructed to perform the superhero and mystical figure exercise. If the user is successful with the central pathway exercise, then the user should have all of the tools necessary to begin eliminating upsetting emotions associated with a particular person, persons, an event, or a situation the user's life and replacing those upsetting emotions with positive emotions that lead to appropriate behaviors.

The object of the central pathway exercise is to provide energy to the body that can destroy the upsetting emotions trapped within the user's body. Generally, all emotions are tied into the line of the central pathway. Upsetting emotions can become trapped within the user's physical body and in any particular area. Positive emotions do not become trapped within the physical body and flow through the body immediately. Since upsetting emotions become trapped, they cause people to repeatedly feel those upsetting emotions whenever the upsetting topic or issue is brought up. Some people may feel sick to their stomach each time a particularly saddening memory is understood and thought about. Also, a person may feel a pain in their neck if the person thinks about someone who angers them. There are seemingly endless patterns and possibilities that can occur from an upsetting issue. A block traps the upsetting emotions within the user's physical body. By lighting up the line of the central pathway in the central pathway exercise, the user is providing their body with sufficient energy to destroy these blocks, essentially.

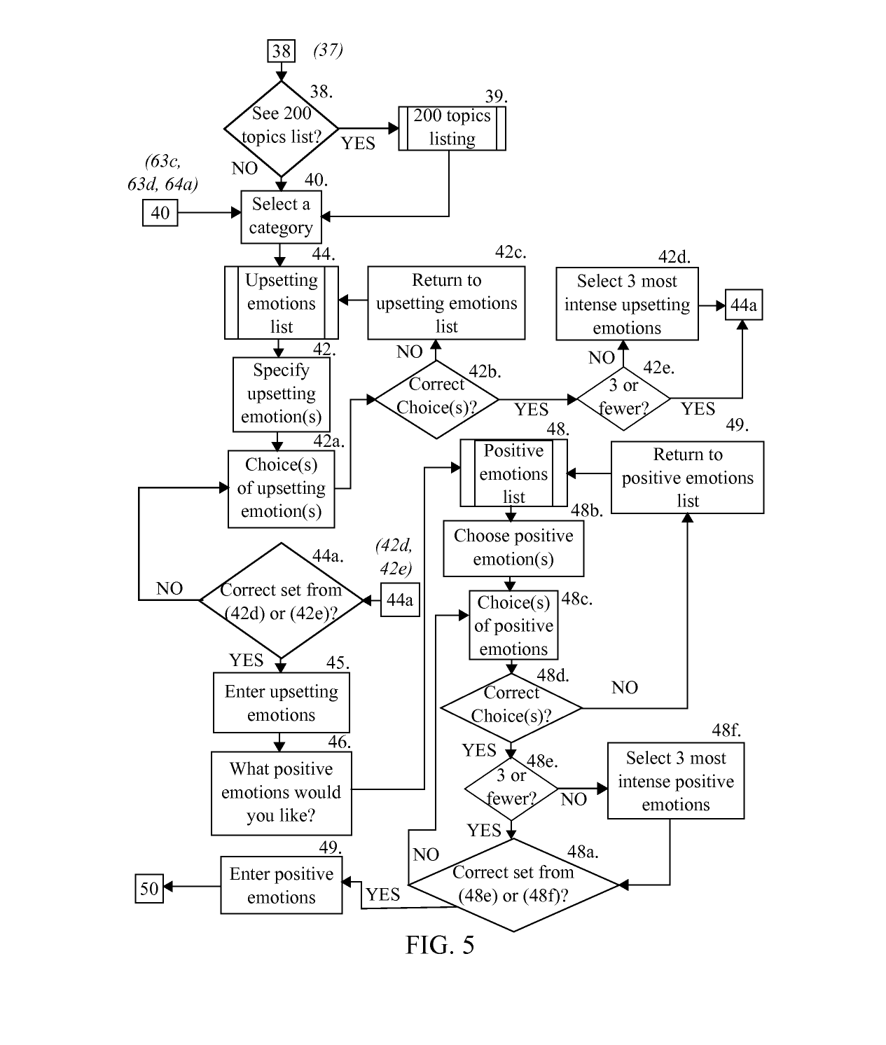

The next step (40) of the present invention, as delineated in FIG. 5, is the emotional selection process in which a user is prompted to select the category of an upsetting issue, the upsetting emotions associated with the memory or issue at hand, and the positive emotions that the user desires to feel in place of the upsetting emotions. The emotional selection process begins by presenting the user with the list of upsetting issues categories, which includes four categories: a specific person in my life, a specific group of people in my life, a particular event in my life, and a specific situation in my life; however, the present invention could implement more or less than four similar or dissimilar categories. The user's upsetting issue should pertain to one of the four provided upsetting categories. The user is not required to specify any details about the selected upsetting issues category. This allows the user to keep such a problem or issue confidential. Once an upsetting issues category is selected, the user is instructed to specify the upsetting emotions that are associated with the selected upsetting issues category (42). A standard list of upsetting emotions are presented to the user, although the user could input their own upsetting emotion if it is not found within this standard list.

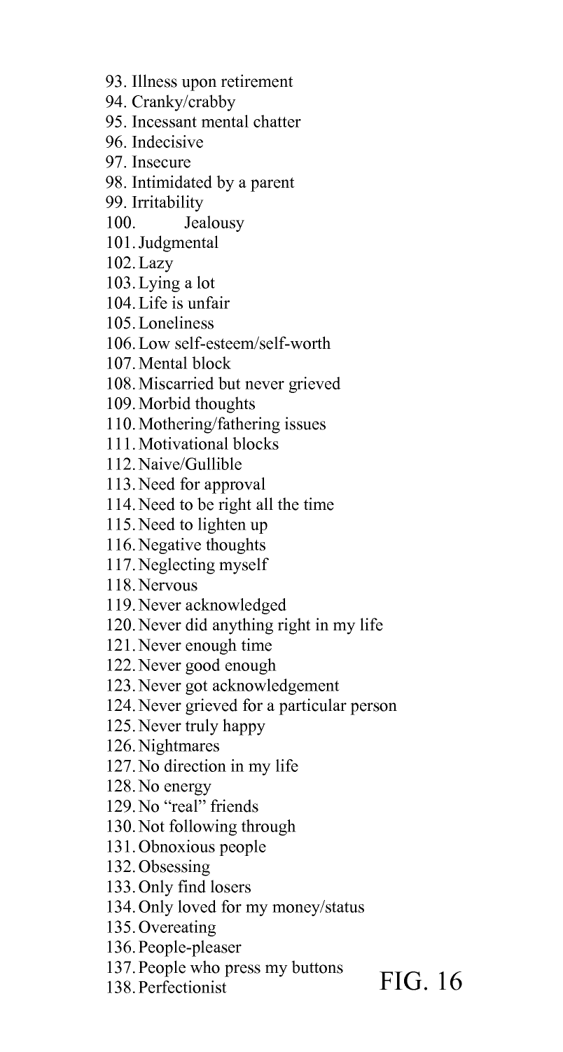

An example list of the upsetting emotions is shown in FIG. 15; however the present invention should not be limited to upsetting emotions contained within this list. The present invention can limit the amount of upsetting emotions selected. For example, the present invention may require the user to only select up to three upsetting emotions that are associated with the selected upsetting issues category. The present invention attempts to target the strongest upsetting emotions. Once the user has selected the upsetting emotions, the user is instructed to choose from a standard list of positive emotions (46), or input a unique positive emotion if not found within the presented list of positive emotions. An example list of the positive emotions is shown in FIG. 16; however the present invention should not be limited to the positive emotions contained in this list. These selected positive emotions will later be used to replace the eliminated upsetting emotions. Therefore, the user must select the desired positive emotions to be felt in place of the upsetting emotions upon completion of the emotional transformation process. The user should be able to input their own positive emotions if the positive emotions that are desired to be felt are not found within the standard list of positive emotions. Once the user has confirmed the selected upsetting issues category, the selected upsetting emotions, and the selected positive emotions, the user proceeds to the next steps and processes.

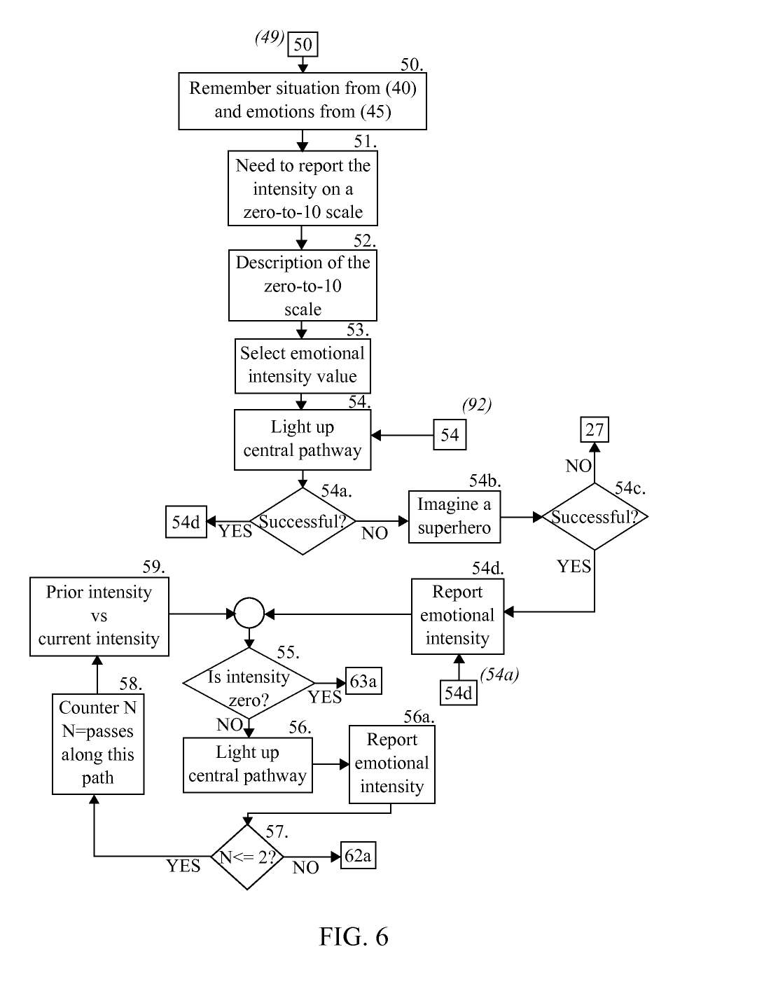

The emotional intensity rating process (50-62a) follows the selection of the upsetting issues category, the upsetting emotions, and the positive emotions. The object of this process is to assign an emotional intensity to the selected upsetting issues category. This allows the present invention to determine if the selected upsetting emotions need to be reduced in emotional intensity. A user could have dissimilar upsetting emotions towards dissimilar issues. The emotional transformation process should succeed in reducing the emotional intensity. The emotional intensity rating process is delineated within FIG. 6. This process begins by instructing the user to remember the situation from the selected upsetting issues category that caused the user to feel the selected upsetting emotions (50). The user is then provided a description of the emotion intensity scale (52). In the preferred embodiment of the present invention, the user should assign a numerical number from zero to ten, with an emotional intensity of zero meaning that no upsetting emotions are felt towards the select upsetting issues category. Next, the user is required to input the emotional intensity of the particular selected upsetting issues category (53). Once the user inputs the emotional intensity, the user is instructed to perform the central pathway exercise (54). Hereinafter, any instance a user is instructed to perform the central pathway exercise it should be assumed that the user is lighting up the line of their central pathway with the gold light. If the user is unsuccessful in performing the central pathway exercise at this point, the user is instructed to perform the superhero and mystical figure exercise (54b). If the user successfully inputs the emotional intensity, then the user proceeds to the next step within the emotion intensity rating process.

The next step within the emotional intensity rating process begins by instructing the user to input the emotional intensity a second time (54d). The software runs a counter to determine the amount of instances that the user has been along this path. These steps are to determine if the emotional intensity has been reduced to less than one directly through performing the central pathway exercise. An emotional intensity between zero and one is determined to be negligible, meaning the user should no longer feel the upsetting emotions towards the user's particular issue. The emotional intensity rating process ends once it has reiterated a preset number of instances. Once the software determines that the emotional transformation process has reached this preset number of instances, the user proceeds to the next steps and processes. However, if the user's inputs an emotional intensity of less than one, the user proceeds to the verification process (63a).

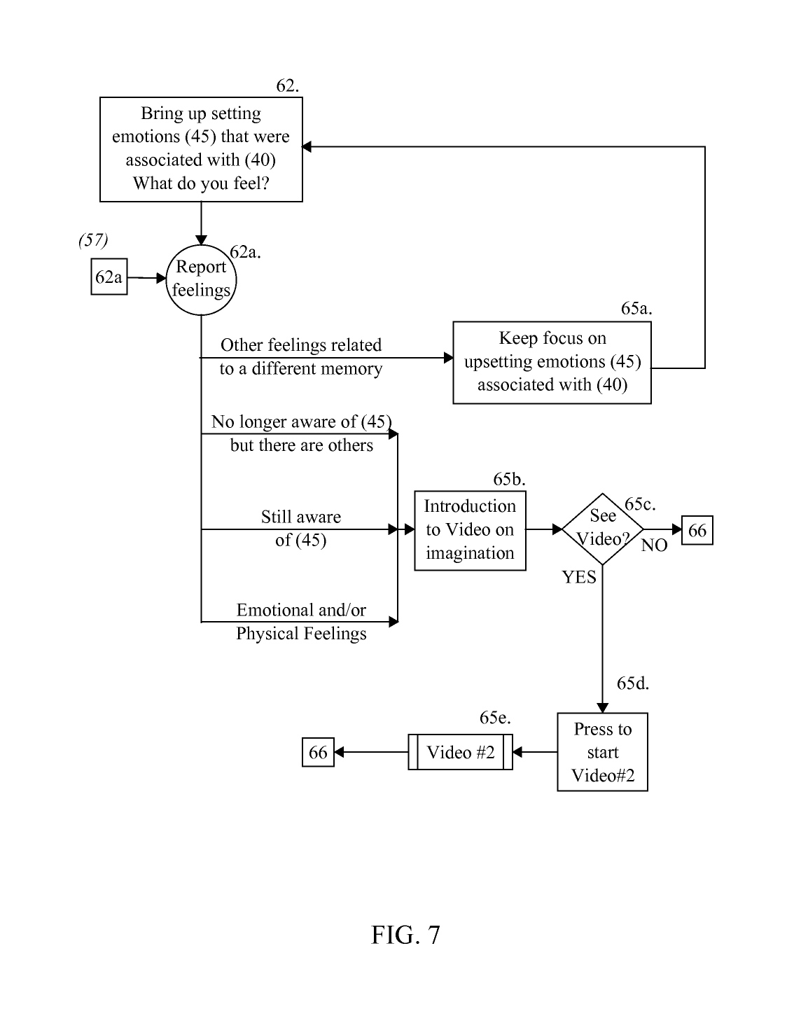

The next process of the present invention, if the user does not input an emotional intensity of less than one during the emotional intensity rating process, is the feeling reporting process (62-66). This process is delineated within FIG. 7. The feeling reporting process begins by instructing the user to recall the upsetting emotions that are associated with the selected issues category (62). The user is instructed to report the current feelings towards to the selected upsetting issues category (62a), which can include: currently has unrelated feelings to a dissimilar upsetting issues category, is no longer aware of the selected upsetting emotions but still has upsetting emotions towards the selected upsetting issues category, is still aware of the selected upsetting emotions that correspond to the current selected upsetting issues category, and if the user currently has emotional and/or physical feelings. If the user currently has unrelated feelings to a dissimilar upsetting issues category, then the user is instructed to remain focused on the selected upsetting issues category (65a) and is required to repeat the feeling reporting process (62). If the user is no longer aware of the selected upsetting emotions but still has upsetting emotions towards the selected upsetting issues category, is still aware of the selected upsetting emotions that correspond to the current selected upsetting issues category, or if the user currently has emotional and/or physical feelings then the user proceeds to the next step within the feeling reporting process. This next step (65b) is to provide the user with a video describing the purpose of the following steps and processes; however, the user should have the option to skip through the video and proceed to the next step and process if desired.

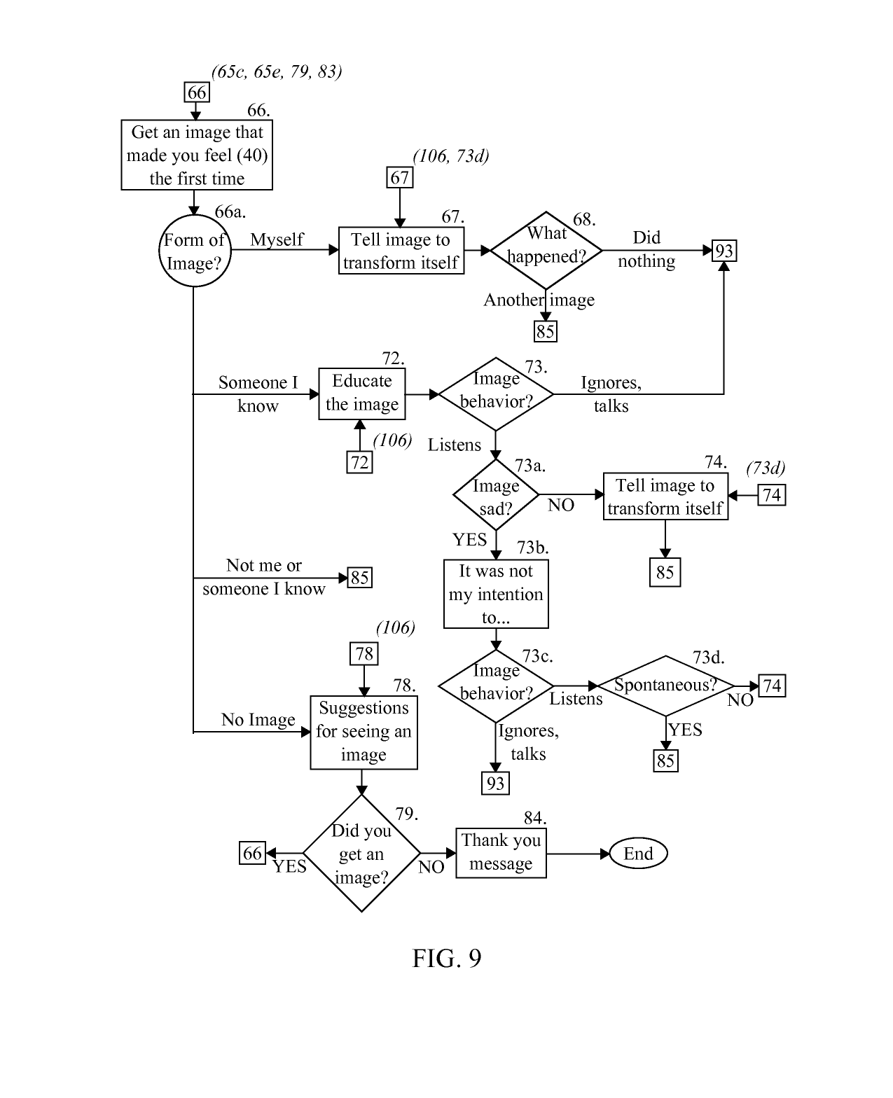

The next process is the image forming process. The image forming process is delineated within FIG. 9. This process begins by instructing the user's imagination to form an image relating to the first instance within the user's life that caused the user to feel the selected upsetting emotions that are associated with the selected upsetting issues category (66). The user should be able to select from four choices, which includes: a user image, a familiar image, an unfamiliar image, or an absent image. By selecting the user image, the user is claiming that the form of the image is self reflection image. By selecting the familiar image, the user is claiming that the form of the image is of someone the user is able to recognize. By selecting the unfamiliar image, the user is claiming that the form of the image does not relate to any persons that the user is cognitively knows. By selecting the absent image, the user is claiming that there is no form in the image and no image has been created by the user's imagination.

If the user selects the user image, the user is instructed to tell the user's imagination to transform the user image into the most positive image with the most positive energy that reconnects the user to the selected positive emotions (67). The user is then instructed to select the reaction to the previous step (68)—either the image did nothing or the image transformed into another image. If the user selects the image did nothing, then the user should be directed to the image destruction process (93). If the user selects the image transformed, then the user should be directed to the image intention process (85). The selection of the familiar image should direct the user to the image education process (72); the selection of the unfamiliar image should direct the user to the image intention process (85); and if the absent image is selected, then an explanation (78) is provided to assist the user in forming an image relating to the selected upsetting emotions corresponding to the selected upsetting issues category. However, if the user is unsuccessful in forming an image during the image forming process, the emotional transformation process should cease and the method of the present invention should be terminated.

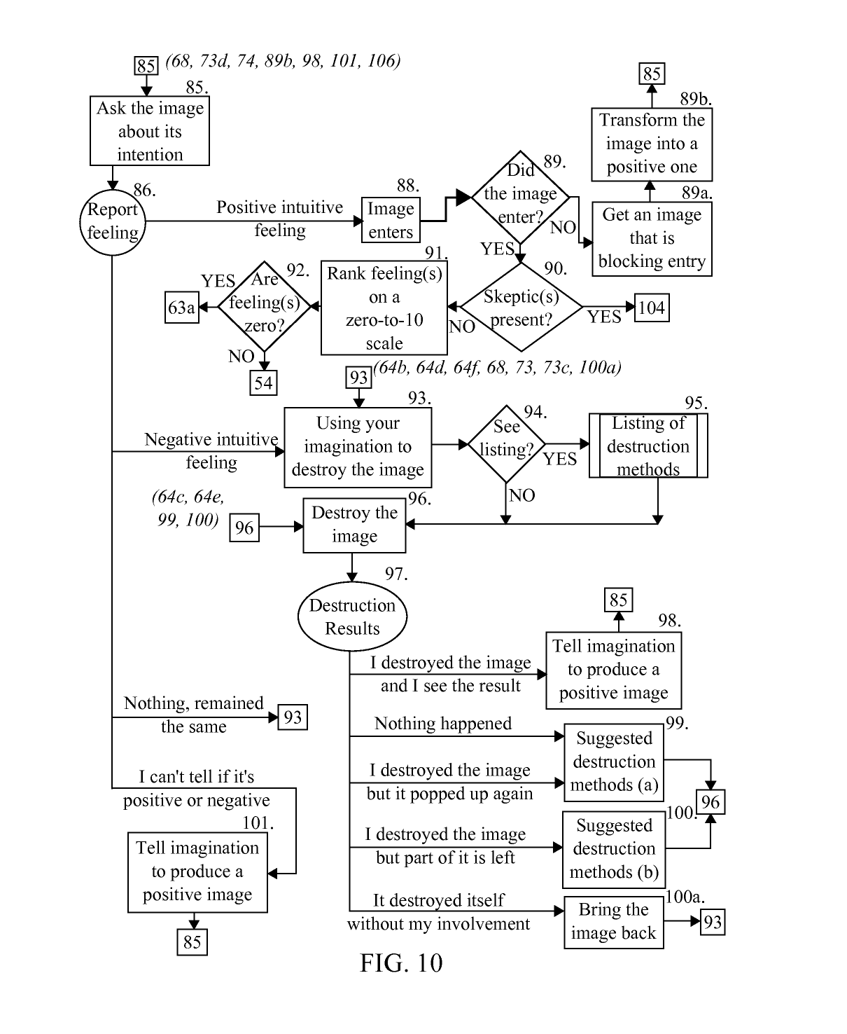

The image intention process is delineated within FIG. 10. The object of the image intention process is to understand the underlying motivation of the current image held within the user's imagination. The image intention process begins by instructing the user to report from four choices about the intention of the image held within the user's imagination (86): a positive intuitive feeling, an upsetting intuitive feeling, a stagnant feeling, or an uncertain feeling. Each selection directs the user to a particular step or process.

By reporting a positive intuitive feeling, the user is claiming that the current image held within the imagination is positive and they are aware of the strong positive feeling associated with this image. The user is then instructed to imagine that this image in tandem with the selected positive emotions enters into every part of their body (88). Essentially, a user's imagination should be able to understand the function of this process and react accordingly. The user is then instructed to report the response (89) of the previous step—if the image entered or if the image did not enter. If the image did not enter into the user's body then the user's imagination is instructed to form an image of the blockage preventing the image from entering (89a). The user should be able to form an image within the imagination of this block. Once the user's imagination has created an image of this block, the user proceeds to the next step. This next step instructs the user to transform the created image of the block into the most positive image with the most positive energy (89b). In some instances this may be difficult and the user may be required to perform the superhero and mystical figure exercise. Upon successfully transforming the block into the most positive image with the most positive energy, the user is directed to the beginning of the image intention process (85) and the image intention process reiterates. If the user reports that the image did enter, the user proceeds to another step. This step instructs the user to determine if the user feels any skeptic or doubt about feeling the selected positive emotions (90). The user should be presented two choices and is instructed to report if this positive image has been wholesomely accepted into every part of the user's body. The two choices should be: a skeptic present or no skeptic present. By reporting a skeptic present, the user is claiming that a doubt or skeptic is held within the mind or body about wholesomely accepting the positive image—the user is then directed to the skeptic process (104). By reporting no skeptic present, the user is claiming that the image has entered wholesomely into the user's body without any doubt or any skeptic; the user is then instructed to input the current emotional intensity relating to the selected upsetting issues category again (91). If the user inputs an emotional intensity of less than one, the user should be directed to the verification process (54a); however if the user inputs an emotional intensity greater than one, then user is redirected back to the beginning of the central pathway exercise (54). Any steps or processes following the central pathway exercise are reiterated thereafter.

By reporting a negative intuitive feeling, the user is claiming that the current image that has formed within the imagination is not positive and an upsetting feeling is felt. The user is then directed to perform the image destruction exercise (93) in order alleviate the upsetting feeling associated with the current image within their imagination.

By reporting the stagnant feeling, the user is claiming that currently the intention of the image held within their imagination has remained unchanged throughout the emotional transformation process. It is important to sense a change in the intention of the image held within the user's imagination, and an unchanged feeling means that upsetting underlying feelings are still current with the issue of the selected upsetting issues category. Thereafter, if the user selects the stagnant feeling, the user is directed to perform the image destruction exercise (93).

By reporting the uncertain feeling, the user is claiming that the current image of the image being helpful held within the imagination could either be positive or upsetting. However, the user is unable to determine which type of intention it is. The user is then instructed to tell the imagination to create another image that lets the user know absolutely, 100%, if this first image at hand is here to help them or not (101). If so, the user should welcome the initial image to come inside the user's heart, spirit and every cell in the user's body. If not, the user is directed to the beginning of the image intention process (85).

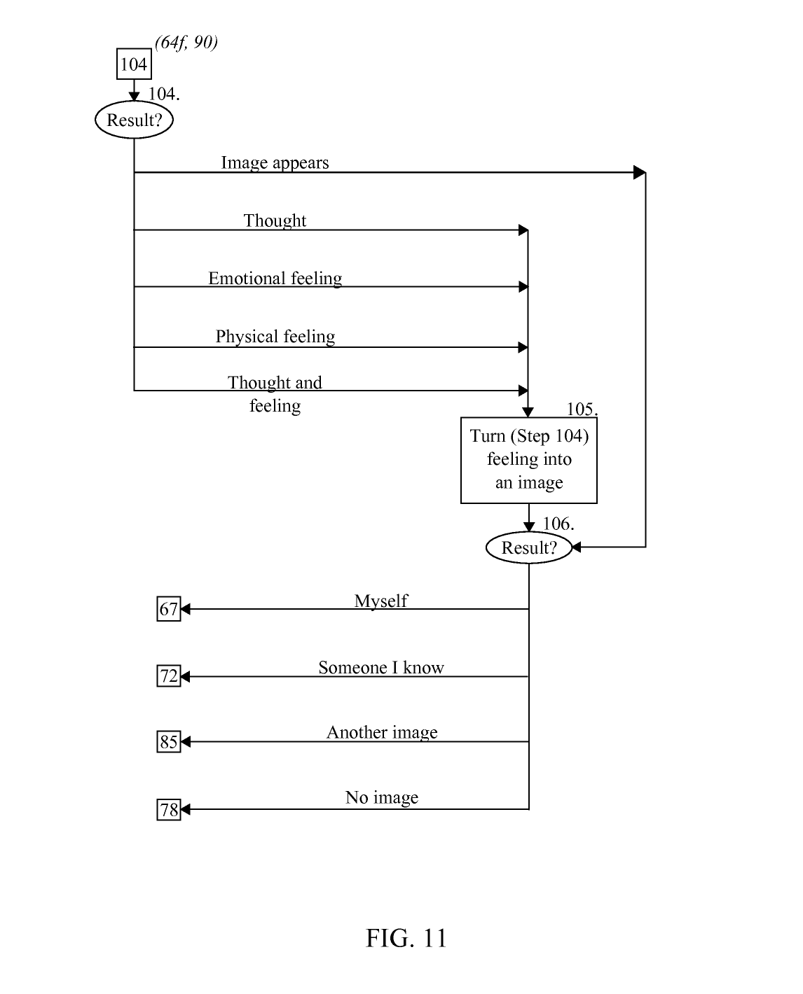

The skeptic process is delineated within FIG. 11. The object of this process is to eliminate any doubt or skeptic towards wholesomely accepting a positive image and the selected positive emotions in place of the selected upsetting emotions that corresponds to the selected upsetting issues category. A user should positively sense this experience throughout the entire body upon the completion of the emotional transformation process; the skeptic process assists the user in achieving this end goal. The user is instructed to report the form of the current doubt or skeptic (104): a doubt image, a thought, an emotional feeling, a physical feeling, or a thought and a feeling. If the user reports a thought, an emotional feeling, a physical feeling, or a thought and a feeling, then the user's imagination is instructed to transform the thought or feeling into an image (105). The imagination should transform the image into an image of an unspecified form, denoted as the transformed doubt image. The user is then instructed to report the form of the doubt image or the transformed doubt image (106): a user transformed doubt image, a familiar transformed doubt image, an unfamiliar transformed doubt image, or an absent transformed doubt image.

By reporting the user transformed doubt image, the user is claiming that the transformed doubt image has taken the form of a self reflection image. The user should then be directed to the image forming process (67), wherein the user image has been selected. Thereafter, the image forming process reiterates.

By reporting the familiar transformed doubt image, the user is claiming that the transformed doubt image has taken a form that relates to a person or entity familiar to the user. The user should then be directed to the image forming process (72), wherein the familiar image has been selected. Thereafter, the image forming process reiterates from that step forward, particularly through the image education process.

By reporting the unfamiliar transformed doubt image, the user is claiming that the transformed doubt image has taken the form of a person, cartoon character, monster, or an object, as an example, that is unfamiliar to the user. Thereafter, the user is redirected to the beginning of the image intention process (85), wherein the image intention process reiterates.

By reporting the absent transformed doubt image, the user is claiming that the transformed doubt image has taken the form of a person, cartoon character, monster, or an object, as an example, that is unfamiliar to the user. Thereafter, the user is redirected to the image forming process (78), wherein the image forming process reiterates from that step forward.

The image education process is delineated within FIG. 9. The object of the image education process is to have the user inform the current image held within the user's imagination about the current emotional feelings of the user. This process begins by instructing the user to imagine that the user is educating the image currently image held within the imagination (72). The user should only express the emotional feelings without blaming the image for anything. Once the user has finished educating this image, the user is instructed to determine the behavioral response of the image to being education, denoted as the image primary behavior. The user reports the image primary behavior (73): an ignoring behavior, a talking behavior, or a listening behavior. If the user reports either the ignoring behavior or the talking behavior—in which the talking behavior relates to blaming, accusatory, and negative actions, as examples—the user is then directed to perform the image destruction exercise (93). However, if the user reports the listening behavior—in which the listening behavior relates to sympathetic, understanding, and compassionate actions, as examples—the user is then instructed to determine if the image became sad or not sad (73a). The image held within the user's imagination can react to being educated emotionally. It is important to be aware of the reactions of the emotional reactions during the image education process because each emotional reaction needs be treated in a certain manner to successfully complete the emotional transformation process. If the user determines that the image became not sad, the user should be instructed to perform the image transformation exercise (74), in which the user should tell the image currently held within the imagination to transform into the most positive image with the most positive energy, particularly with the selected positive emotions. Thereafter, the user should be redirected back to the beginning of the image intention process (85), wherein the image intention process reiterates. If the user determines that the image became sad, the user should be instructed to reeducate the image (73b). The user should educate the image in such a manner as to tell the image that it was not the user's intention to blame, hurt, or upsettingly affect the image. Also, the user should inform the image exactly how the user is feeling, similar to the initial steps within the image education process. Once the user has reeducated the image, the user is instructed to determine and report the image secondary behavior (73c): an ignoring secondary behavior, a talking secondary behavior, or a listening secondary behavior. If the user reports the ignoring secondary behavior or the talking secondary behavior, the user is instructed to perform the image destruction exercise (93). However, if the user reports the listening secondary behavior, the user is instructed to determine the spontaneity of the image secondary behavior (73d). Basically, the image could have formed into its current image by itself, purely through reacting or the image could have formed into its current image by some other means. If the user determines that the image formed reactively, the user is directed to the beginning of the image intention process (85), wherein the image intention process reiterates. If the user determines that the imaged formed through some other means, the user is instructed to perform the image transformation exercise (74) and should then be directed to the beginning of the image intention process (85), wherein the image intention process reiterates.

The image destruction exercise is delineated within FIG. 10. The object of the image destruction exercise is to destroy an upsetting image absolutely, so that a positive image with positive energy can take the place of this upsetting image. The image destruction exercise begins by providing the user with instructions to destroy the current image withheld in the user's imagination (93). Since the image is only a symbol within the user's imagination and not a living entity, no harm is being done physically. An important and critical requirement of the image destruction exercise is that upon destroying the image, the user must see the results of the destruction within their imagination. If the user needs assistance before proceeding to the next step within this exercise, an explanation is provided and a list of destruction methods is displayed (95). Once the user is ready, the user proceeds to the next step. This next step (96) instructs the user to destroy the image using any desired destruction method that could be a destruction method from the list of destruction methods. The user should then be required to select from five destruction result choices (97): destroyed image and see the result, nothing happened, destroyed image yet image returned, destroyed image yet fragments remain, or image destroyed without involvement. If the user selects a destroyed image and see the result, then the user is instructed to tell the imagination to produce a positive image with the most positive energy (98), particularly relating to the selected positive emotions; thereafter, the user should be redirected to the beginning of the image intention process (85), wherein the image intention process reiterates. If the user selects either nothing happened or destroyed image yet image returned, then the user should then be presented with a list of suggested destruction methods (99). These suggested destruction methods should help the user successfully destroy the image. The user should then be redirected to the beginning of the image destruction exercise to destroy the image again (96). If the user selects the destroyed image yet fragments remain, the user is presented with a secondary list of suggested destruction methods so that the image can be successfully destroyed (100). If the user selects image destroyed without user involvement, the user is claiming that the image did in fact get destroyed within the user's imagination but the user did not intentionally perform any destruction methods to achieve the image's destruction. The user should then be instructed to recall or recreate the image before it was destroyed (100a) and then directed to the beginning of the image destruction exercise (93). The upsetting image must be completely annihilated by the user within their imagination in order for the image destruction exercise to be successfully completed.

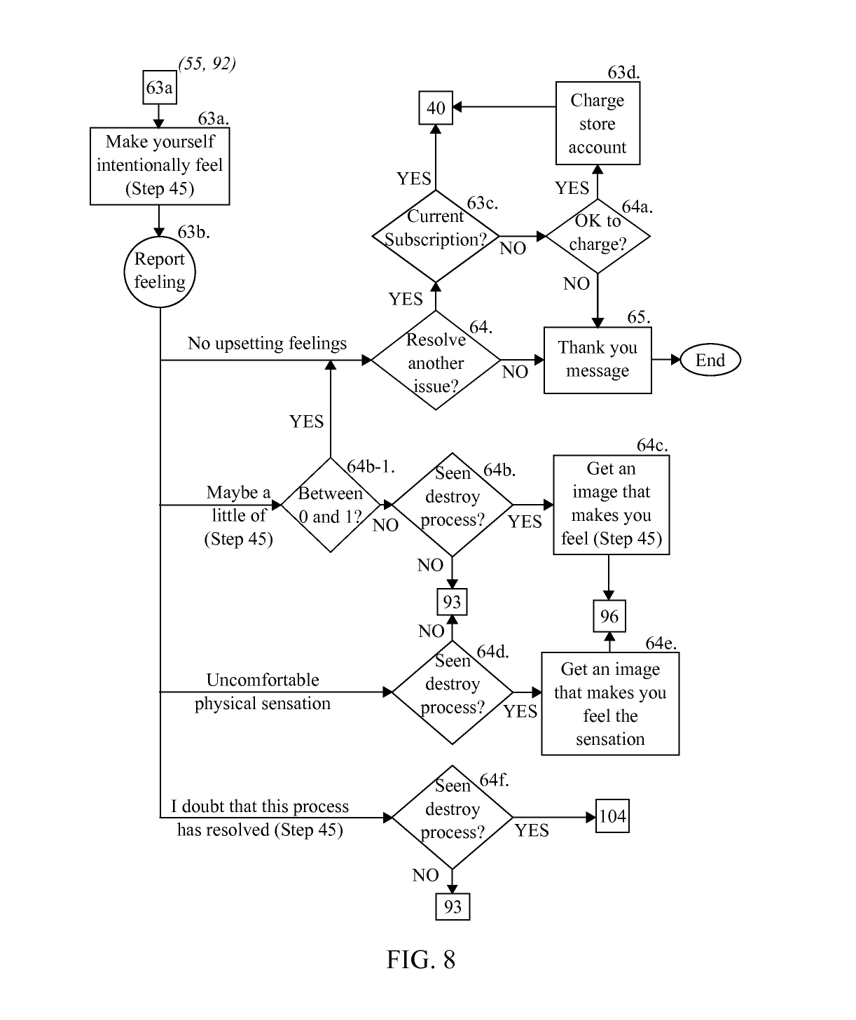

The verification process is delineated within FIG. 8. The object of the verification process is for the user to ensure that the emotional transformation process has been entirely effective and that the selected upsetting emotions and the initial emotion intensity assigned to the selected upsetting issues category has been reduced to a minimal magnitude or to zero. This process begins by instructing the user to intentionally, or to forcefully, feel the selected upsetting emotions corresponding to the issue of the selected upsetting issues category (63a). The selected upsetting emotions and the selected upsetting issues category could be displayed if the user cannot recall this information at this stage of the emotional transformation process. The user is then required to select from four responses (63b): no upsetting feeling, minimal upsetting feeling, an uncomfortable physical feeling, or a doubt of the emotional transformation process. If the user selects no upsetting feelings, the user is instructed that the emotional transformation process has been completed. If the user is unable to feel the upsetting emotions by attempting to intentionally feel the upsetting emotions, then the emotional transformation has been successful. However, the user can elect to resolve another issue (64), and if the user selects this choice, then the user is redirected to the beginning of the emotional transformation process (40) to perform the method of the present invention again.

By selecting the minimal upsetting feeling, the user is claiming that their current feeling towards the issue of the selected upsetting issues category is not entirely upsetting but not entirely positive. The user is then instructed to assign a final emotional intensity (64b-1), which should be an estimate of the emotion intensity, to the selected upsetting issues category. If the value is less than one, the emotional transformation process is determined to be complete, in which the user can begin a new emotional transformation process if desired. However, if the user assigns an emotional intensity greater than one, the user is instructed to perform the image destruction process again (93).

By selecting uncomfortable physical sensation, the user is claiming that the selected upsetting emotions may have been eliminated but not completely and further assistance is required. The user should have completely and utterly eliminated any upsetting emotion towards the issue of the selected upsetting issues category in order for the emotional transformation process to be successful. Therefore, the user is instructed to perform the image destruction exercise again. (93)

By selecting a doubt of the emotional transformation process, the user is claiming that they currently have doubt about the emotional transformation process and its effectiveness in permanently eliminating the underlying repeating patterns causing upsetting emotions. The user may either have been unsuccessful throughout the emotional transformation process or may need to reiterate some of the process or perform some of the exercises again. The user is then instructed to either perform the image destruction exercise again (93) or to return to the skeptic process (104). The user should be directed to the beginning of the skeptic process (104) if the user has a feeling of doubt; also, the skeptic process should reiterate.

An alternate embodiment of the present invention could present the user with additional or alternate choices to select from during the aforementioned steps and processes. Also, some choices could be removed. However, the object of the present invention to eliminate the underlying repeating patterns that cause upsetting emotions to a specific topic, issue, or behavior should be achieved through this alternate embodiment of the present invention. Also, the terminology of the aforementioned choices, processes, exercises, and steps could be altered for as long as the object of the present invention to permanently eliminate upsetting emotions and to replace those upsetting emotions with positive emotions is achieved.

Although the invention has been explained in relation to its preferred embodiment, it is to be understood that many other possible modifications and variations can be made without departing from the spirit and scope of the invention as hereinafter claimed.

What is claimed is:

1. A method of permanently removing repeating upsetting emotions and behaviors associated with a person, persons, events and situations by executing computer-executable instructions stored on a non-transitory computer-readable medium, the method comprises the steps of:
providing a list of upsetting issues categories;
providing a list of upsetting emotions;
providing a list of positive emotions;
providing a plurality of imagination exercises, wherein the plurality of imagination exercises includes an image exercise, an imagination exercise, a central pathway exercise, a superhero and mystical figure exercise, an image replacement exercise, an image transformation exercise, and an image destruction exercise;
providing a plurality of helpful explanations;
determining if an emotional transformation process will be successful through the plurality of imagination exercises and the plurality of helpful explanations;
displaying a series of instructions through a graphic user interface;
rendering an emotional selection process in order to select an upsetting issues category, at least one upsetting emotion, and at least one positive emotion;
rendering an emotional intensity rating process by assigning an emotional intensity to the selected upsetting issues category;
rendering a feeling reporting process by instructing to report a feeling;
rendering an image forming process by instructing to report a form of an upsetting issues category image;
rendering an intention process by instructing to report an intention of an image;
rendering an image education process in order to determine an image primary behavior and an image secondary behavior;
rendering the skeptic process in order to eliminate a doubt or a skeptic;
rendering the image destruction exercise in order to destroy an image and to eliminate the selected upsetting emotions;
rendering a verification process in order to complete the emotional transformation process.

2. The method of permanently removing repeating upsetting emotions and behaviors associated with a person, persons, events and situations by executing computer-executable instructions stored on a non-transitory computer-readable medium, the method as claimed in claim 1, wherein the plurality of helpful explanations includes an image explanation, an imagination explanation, a superhero and mystical figure explanation, a body covering explanation, a body cleansing explanation, an image enclosure explanation, an image coating explanation, a bubble absorption explanation, a central pathway explanation, and an image destruction explanation.

3. The method of permanently removing repeating upsetting emotions and behaviors associated with a person, persons, events and situations by executing computer-executable instructions stored on a non-transitory computer-readable medium, the method as claimed in claim 1 comprises the steps of:
instructing to perform the plurality of imagination exercises in order to assist a step within the emotional transformation process;
instructing to perform a body covering exercise, a body cleansing exercise, an image enclosure exercise, an image coating exercise, and a bubble absorption exercise in order to provide an understanding of the emotional transformation process; and
discontinuing the emotional transformation process if the body covering exercise, the body cleansing exercise, the image enclosure exercise, the image coating exercise, or the bubble absorption exercise is unsuccessful.

4. The method of permanently removing repeating upsetting emotions and behaviors associated with a person, persons, events and situations by executing computer-executable instructions stored on a non-transitory computer-readable medium, the method as claimed in claim 1 comprises the steps of:
discontinuing the emotional transformation process if at least one of the plurality of imagination exercises is unsuccessful.

5. The method of permanently removing repeating upsetting emotions and behaviors associated with a person, persons, events and situations by executing computer-executable instructions stored on a non-transitory computer-readable medium, the method as claimed in claim 1 comprises the step of:
instructing to select a category from the list of upsetting issues categories;
instructing to select at least one upsetting emotion from the list of upsetting emotions;
instructing to select at least one positive emotion from the list of positive emotions; and
rendering the emotional intensity rating process upon receiving the selected upsetting issues category, the selected upsetting emotions, and the selected positive emotions.

6. The method of permanently removing repeating upsetting emotions and behaviors associated with a person, persons, events and situations by executing computer-executable instructions stored on a non-transitory computer-readable medium, the method as claimed in claim 1 comprises the steps of:
instructing to assign the emotional intensity to the selected upsetting issues category;
instructing to perform the central pathway exercise;
rendering the verification process if the emotional intensity is less than one;
reiterating the emotional intensity rating process if the emotional intensity is greater than one, wherein each cycle of the emotional intensity rating process is counted; and
rendering the feeling reporting process upon completing a preset number of cycles of the emotional intensity rating process.

7. The method of permanently removing repeating upsetting emotions and behaviors associated with a person, persons, events and situations by executing computer-executable instructions stored on a non-transitory computer-readable medium, the method as claimed in claim 6 comprises the steps of:
instructing to perform the central pathway exercise if the emotional intensity is greater than one; and
displaying the emotional intensity during each reiteration of the emotional intensity rating process, wherein each inputted emotional intensity is displayed.

8. The method of permanently removing repeating upsetting emotions and behaviors associated with a person, persons, events and situations by executing computer-executable instructions stored on a non-transitory computer-readable medium, the method as claimed in claim 1 comprises the steps of:
instructing to report the feeling corresponding to the selected upsetting issues category and the selected upsetting emotions, wherein the feeling is a feeling relating to a dissimilar upsetting issue, an unrelated upsetting emotions feeling, an aware upsetting emotions feeling, an emotional feeling, or a physical feeling;
instructing to focus on the selected upsetting issues category selected upsetting emotions if the feeling relating to a dissimilar upsetting issue is reported;
reiterating the feeling reporting process if the feeling relating to a dissimilar upsetting issue is reported;
displaying a video if the unrelated upsetting emotions feeling, the aware upsetting emotions feeling, the emotional feeling, or the physical feeling is reported; and
instructing to perform the image forming process if the unrelated upsetting emotions feeling, the aware upsetting emotions feeling, the emotional feeling, or the physical feeling is reported.

9. The method of permanently removing repeating upsetting emotions and behaviors associated with a person, persons, events and situations by executing computer-executable instructions stored on a non-transitory computer-readable medium, the method as claimed in claim 1 comprises the steps of:
instructing to report the form of the selected upsetting issues category image, wherein the form of the selected upsetting issues category image is a user image, a familiar image, an unfamiliar image, or an absent image;
instructing to perform the image transformation exercise if the user image is reported;
instructing to perform the image education process if the familiar image is reported;
instructing to perform the image intention process if the unfamiliar image is reported; and
displaying an image suggestion if the absent image is reported.

10. The method of permanently removing repeating upsetting emotions and behaviors associated with a person, persons, events and situations by executing computer-executable instructions stored on a non-transitory computer-readable medium, the method as claimed in claim 9 comprises the steps of:
instructing to report if the user image did nothing or user image transformed into a positive image;
instructing to perform the image destruction exercise if the user image did nothing is reported; and
instructing to perform the image intention process if user image transformed into a positive image is reported.

11. The method of permanently removing repeating upsetting emotions and behaviors associated with a person, persons, events and situations by executing computer-executable instructions stored on a non-transitory computer-readable medium, the method as claimed in claim 9 comprises the steps of:
instructing to report if the absent image transformed into the user image, the familiar image, or the unfamiliar image or the absent image did not transform into the user image, the familiar image, or the unfamiliar image;
discontinuing the emotional transformation process if the absent image did not transform into the user image, the familiar image, or the unfamiliar image is reported; and
reiterating the image forming process if the absent image transformed into the user image, the familiar image, or the unfamiliar image is reported.

12. The method of permanently removing repeating upsetting emotions and behaviors associated with a person, persons, events and situations by executing computer-executable instructions stored on a non-transitory computer-readable medium, the method as claimed in claim 1 comprises the steps of:
instructing to report the intention of an image, wherein the intention of an image is a positive intuitive feeling, a negative intuitive feeling, a stagnant feeling, or an uncertain feeling;
instructing to allow the image to enter if the positive intuitive feeling is reported;
instructing to perform the image destruction exercise if the negative intuitive feeling is reported;
instructing to perform the image destruction exercise if the stagnant feeling is reported; and
instructing to produce a positive image if the uncertain feeling is reported.

13. The method of permanently removing repeating upsetting emotions and behaviors associated with a person, persons, events and situations by executing computer-executable instructions stored on a non-transitory computer-readable medium, the method as claimed in claim 12 comprises the steps of:
instructing to report the image entered or the image did not enter;
instructing to perform the image transformation exercise if the image did not enter is reported;
instructing to report a skeptic is present or a skeptic is not present if the image entered is reported;
instructing to perform the skeptic process if the skeptic is present is reported; and
reiterating the emotional intensity rating process if the skeptic is not present is reported.

14. The method of permanently removing repeating upsetting emotions and behaviors associated with a person, persons, events and situations by executing computer-executable instructions stored on a non-transitory computer-readable medium, the method as claimed in claim 12 comprises the step of:
reiterating the image intention process if the uncertain feeling is reported.

15. The method of permanently removing repeating upsetting emotions and behaviors associated with a person, persons, events and situations by executing computer-executable instructions stored on a non-transitory computer-readable medium, the method as claimed in claim 1 comprises the steps of:
instructing to intentionally feel the selected upsetting emotions;
instructing to report no upsetting feelings, minimal upsetting feelings, an uncomfortable physical sensation, or a doubt of the emotional transformation process;
completing the emotional transformation process if no upsetting feelings is reported;
instructing to assign a final emotional intensity to the selected upsetting issues category if minimal upsetting feelings is reported;
instructing to perform the image destruction process if the uncomfortable physical sensation is reported or if the final emotional intensity is greater than one; and
instructing to report perform either the skeptic process or the image destruction exercise if the doubt of the emotional transformation process is reported.

16. The method of permanently removing repeating upsetting emotions and behaviors associated with a person, persons, events and situations by executing computer-executable instructions stored on a non-transitory computer-readable medium, the method as claimed in claim 15 comprises the steps of:
instructing to report another issue needs resolved or another issue does not need resolved upon completing the emotional transformation process or if the final emotional intensity is less than one;
reiterating the emotional selection process if another issue needs resolved is reported; and
discontinuing the emotional transformation process if another issue does not need resolved is reported.

17. The method of permanently removing repeating upsetting emotions and behaviors associated with a person, persons, events and situations by executing computer-executable instructions stored on a non-transitory computer-readable medium, the method as claimed in claim 1 comprises the steps of:
instructing to report the image primary behavior, wherein the image primary behavior is a listening behavior, an ignoring behavior, or a talking behavior;
instructing to perform the image destruction exercise if the ignoring behavior or the talking behavior is reported;
instructing to report an image sad or an image not sad if the listening behavior is reported;
instructing to perform the image transformation exercise and the image intention process if the image not sad is reported; and
instructing to determine the image secondary behavior if the image sad is reported.

18. The method of permanently removing repeating upsetting emotions and behaviors associated with a person, persons, events and situations by executing computer-executable instructions stored on a non-transitory computer-readable medium, the method as claimed in claim 1 comprises the steps of:
instructing to report the image secondary behavior, wherein the image secondary behavior is a listening secondary behavior, an ignoring secondary behavior, or a talking secondary behavior;
instructing to perform the image destruction exercise if the ignoring secondary behavior or the talking secondary behavior is reported;
instructing to report the image secondary behavior is spontaneous or the image secondary behavior is not spontaneous if the listening secondary behavior is reported;
instructing to perform the image transformation exercise and the image intention process if the image secondary behavior is not spontaneous is reported; and
instructing to perform the image intention process if the image secondary behavior is spontaneous is reported.

19. The method of permanently removing repeating upsetting emotions and behaviors associated with a person, persons, events and situations by executing computer-executable instructions stored on a non-transitory computer-readable medium, the method as claimed in claim 1 comprises the steps of:
instructing to imagine destroying an image;
displaying a list of destruction methods;
instructing to destroy the image using a destruction method from the list of destruction methods;
instructing to report an image destruction result, wherein the image destruction result is destroyed image and see the result, nothing happened, destroyed image yet image returned, destroyed image yet fragments remain, or destroyed image without involvement; and
instructing to produce a positive image if destroyed image and see the result is reported, wherein the image intention process reiterates.

20. The method of permanently removing repeating upsetting emotions and behaviors associated with a person, persons, events and situations by executing computer-executable instructions stored on a non-transitory computer-readable medium, the method as claimed in claim 19 comprises the steps of:
displaying a list of suggested destruction methods if nothing happened or destroyed image yet image returned is reported;
instructing to destroy the image using a suggested destruction method from the list of suggested destruction methods if nothing happened or destroyed image yet image returned is reported;
displaying a list of secondary suggested destruction methods if destroyed image yet fragments remains is reported;
instructing to destroy the image using a secondary suggested destruction method from the list of secondary suggested destruction methods if destroyed image yet fragments remains is reported;
instructing to recreate the image if destroyed image yet fragments remains is reported; and
instructing to repeat the image destruction exercise if destroyed image yet fragments remains is reported.
